(19) United States
(12) Patent Application Publication
(10) Pub. No.: US 2020/0122996 A1
(43) Pub. Date: Apr. 23, 2020

(54) Beverage Supply Device

(71) Applicant: SANDEN RETAIL SYSTEMS CORPORATION, Isesaki-shi (JP)

(72) Inventors: Takao MATSUMOTO, Isesaki-shi (JP); Shinya ARAI, Isesaki-shi (JP)

(21) Appl. No.: 16/612,523

(22) PCT Filed: Apr. 23, 2018
(86) PCT No.: PCT/JP2018/017360

§ 371 Date: Nov. 11, 2019

(30) Foreign Application Priority Data
May 19, 2017 (JP) 2017-100329

(51) Int. Cl. B67D 1/12; A47J 31/40; A47J 31/46; B67D 1/07

(52) U.S. Cl. CPC B67D 1/1256; B67D 1/07; A47J 31/46; A47J 31/402

(57) ABSTRACT

A coffee machine 1 having a body part 3, a door 2 that is openably and closably supported by the body part 3 and a cup station at which a cup is placed, the coffee machine 1 supplying milk from a milk nozzle 25 a distal end of which is disposed above the cup, to the cup placed at the cup station, in which the coffee machine 1 includes a movable nozzle support unit 27 that supports the milk nozzle 25 and is disposed in the body part 3 so as to be movable between a first position at which the distal end of the milk nozzle 25 is above the cup while the door 2 is closed and a second position at which the distal end of the milk nozzle 25 is retracted from above the cup and a nozzle movement unit 50 that moves a pusher 52 so as to extend to and retract from the door 2. The pusher 52 is extended to push the movable nozzle support unit 27 and move the movable nozzle support unit 27 to a supply position.

### TECHNICAL FIELD

The present invention relates to a beverage supply apparatus that supplies and provides a beverage into a cup.

### BACKGROUND ART

Beverage supply apparatuses which are installed in a shop or the like to automatically pour and provide a beverage such as coffee into cups are developed.

For example, a beverage supply apparatus described in Patent Document 1 has a structure of pouring and supplying a beverage such as coffee from a nozzle into a cup placed below the nozzle. Furthermore, the beverage supply apparatus according to Patent Document 1 is provided with an actuator such as an electric motor at a bracket that supports the nozzle. The apparatus is configured such that the nozzle can be moved by the actuator and when the supply of the beverage into the cup is completed, the nozzle is moved to a standby position retracted from above the cup. After the supply of the beverage into the cup is completed, it is thereby possible to prevent the beverage remaining in the nozzle from dripping from the nozzle distal end and being stuck around the cup, so-called post-drip.

### PRIOR ART DOCUMENT

### Patent Document

Patent Document 1: Japanese Utility Model Laid-Open No. S62-71787

### SUMMARY OF THE INVENTION

### Problems to be solved by the Invention

By the way, the nozzle and a beverage supply path upstream of the nozzle of the beverage supply apparatus as described in Patent Document 1 are required to be cleaned periodically from the standpoint of hygiene.

Especially, in recent years, among beverage supply apparatuses that provide coffee and milk, like cafe latte, poured into a cup, apparatuses are being developed which store raw milk, whip a predetermined amount of the raw milk and supply it with coffee into a cup. Such beverage supply apparatuses that provide a beverage containing raw milk are required to conduct strict sanitary control and need to increase the frequency of cleaning.

However, in the case of the beverage supply apparatus in Patent Document 1 in which the nozzle is made movable and the nozzle and the actuator are configured as a combined unit, the configuration in the vicinity of the nozzle is complicated, causing maintainability such as removal of the nozzle and cleaning to deteriorate. When the interior of the body part in the vicinity of the nozzle is cleaned using hot water/water, hot water/water may splash on the actuator and cause malfunction.

The present invention has been devised to solve such a problem and it is an object of the present invention to provide a beverage supply apparatus capable of preventing post-drip from a nozzle, facilitating maintenance such as cleaning of the nozzle and surrounding parts and protecting an actuator for moving the nozzle.

### Means for Solving the Problems

In order to achieve the above object, an aspect of the present invention is directed to a beverage supply apparatus provided with a body part, a door openably/closably supported by the body part and a cup station at which a cup is placed, the beverage supply apparatus supplying a beverage from a nozzle, a distal end of which is disposed above the cup, to the cup placed at the cup station, the beverage supply apparatus including a nozzle support unit that supports the nozzle and is disposed in the body part so as to be movable between a first position at which the distal end of the nozzle is above the cup while the door is closed and a second position which is a position where the distal end of the nozzle is retracted from above the cup, and an actuator that is disposed at the door and moves the nozzle support unit.

The beverage supply apparatus is preferably provided with first biasing means for biasing the nozzle support unit toward the second position.

The beverage supply apparatus is preferably provided with a pusher that is driven by the actuator to protrude, push the nozzle support unit and move the nozzle support unit to the first position, and the pusher is preferably provided with a proximal end part that is moved by the actuator, a distal end part that is extendible with respect to the proximal end part and pushes the nozzle support unit, and second biasing means for biasing the distal end part in an extending direction with respect to the proximal end part.

The beverage supply apparatus is preferably provided with holding means for holding the nozzle support unit at the first position.

### Advantageous Effects of the Invention

According to the beverage supply apparatus of the present invention, since the nozzle can move to the second position which is the position at which the nozzle is retracted from above the cup, it is possible to prevent post-drip of the beverage into the cup by moving the nozzle to the second position after the beverage is supplied into the cup.

Furthermore, since the actuator for moving the nozzle support unit is disposed at the door, the nozzle and the nozzle support unit disposed at the body part and the actuator disposed at the door have different structures. Therefore, it is possible to easily remove the nozzle and the nozzle support unit from the body part and easily perform maintenance such as cleaning of the nozzle and the nozzle support unit.

By opening the door, the body part can be separated from the door. Thus, when cleaning the body part in the vicinity of the nozzle using hot water/water, it is possible to prevent hot water/water from splashing on the actuator disposed at the door and protect the actuator.

### BRIEF DESCRIPTION OF THE DRAWINGS

FIG. 1 is a front outline view of a coffee machine according to an embodiment of the present invention;

FIG. 2 is a front view of the coffee machine when a door is opened;

FIG. 3 is a front view illustrating an overall structure of a nozzle unit and a nozzle lower tray;

FIG. 4 is a top view illustrating states of a nozzle support unit and the nozzle lower tray when milk is not supplied;

FIG. 5 is a top view illustrating states of the nozzle support unit and the nozzle lower tray when milk is supplied;

FIG. 6 is a top view of the nozzle lower tray;

FIG. 7 is a perspective view of the nozzle lower tray;

FIG. 8 is a traverse cross-sectional view illustrating states of the nozzle unit and a nozzle moving unit when milk is supplied; and

FIG. 9 is a traverse cross-sectional view illustrating states of the nozzle unit and the nozzle moving unit while the door is being opened.

### MODE FOR CARRYING OUT THE INVENTION

Hereinafter, an embodiment of the present invention will be described with reference to the accompanying drawings.

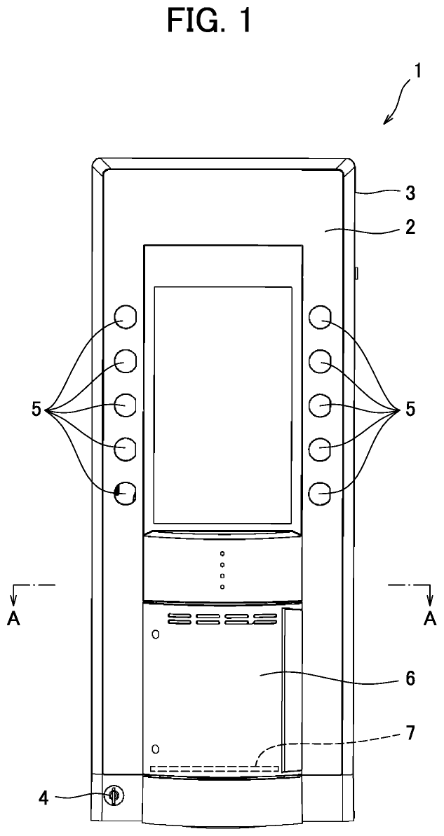

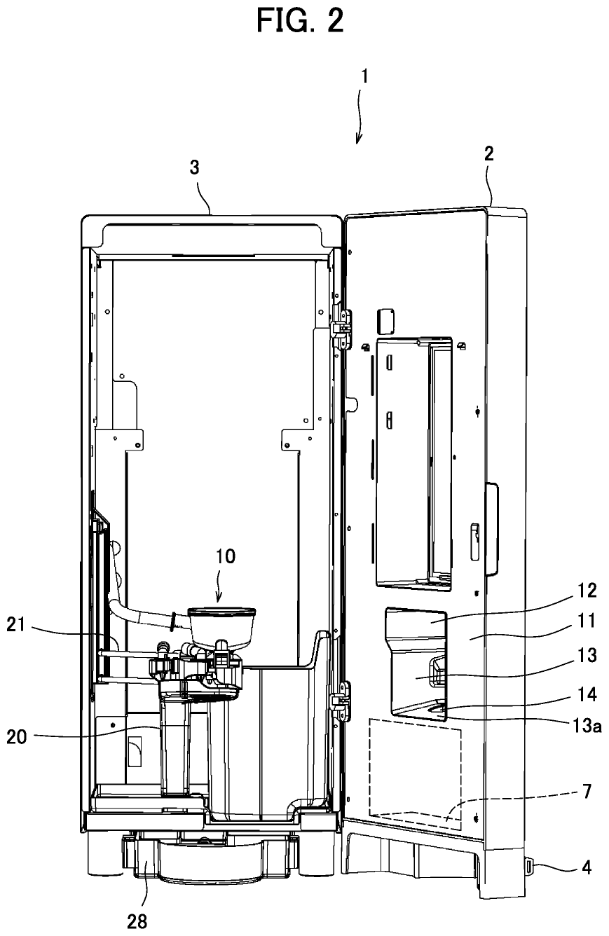

FIG. 1 is an outline view of a coffee machine 1 according to an embodiment of the present invention. FIG. 2 is a front view of the coffee machine 1 when a door 2 is opened.

The coffee machine 1, which is a beverage supply apparatus according to an embodiment of the present invention is an apparatus placed at a store such as a convenience store to provide a beverage such as coffee only or a mixture of coffee and milk such as cafe latte or cappuccino.

As shown in, FIGS. 1 and 2, the coffee machine 1 of the present embodiment is provided with a substantially rectangular box-shaped body part 3 and a rectangular box-shaped door 2 that covers the front surface of the body part 3.

Inside the body part 3, there are a canister for storing coffee beans, a hot water tank, a raw milk tank for storing raw milk, a whipping unit for whipping the raw milk, a coffee mill for milling the coffee beans and an extraction unit for extracting coffee, or the like, which are not shown.

The door 2 is formed into a box shape including a space therein and is supported by the body part 3 so as to be opened or closed in a left-right direction swinging with the end part on the right side as a fulcrum. The door 2 can be locked in a closed state by a removable key 4 and is opened when a raw material such as coffee beans is supplied or at the time of maintenance such as cleaning.

Selection switches 5 for selecting a beverage such as coffee, cafe latte are provided on the front of the door 2. A slide door 6 is provided at the front bottom of the door 2 and a cup station 7 at which a cup is placed is provided in the slide door 6. The cup station 7 is provided in the door 2.

The body part 3 is provided with a nozzle unit 10 that supplies a beverage into a cup from the extraction unit, the raw milk tank or the like. The nozzle unit 10 is disposed so that it is positioned above the cup station 7 when the door 2 is closed.

A space 12 for housing the nozzle unit 10 in the door 2 is formed in a rear surface panel 11 positioned on the body part side of the door 2 while the door 2 is closed. The space 12 is positioned above the cup station 7, covered with a partition wall 13 on the top, bottom, left and right, and is partitioned from other spaces in the door 2. Note that a hole 14 for allowing a beverage to pass from the nozzle unit 10 to the cup station 7 side is opened in the partition wall 13a below.

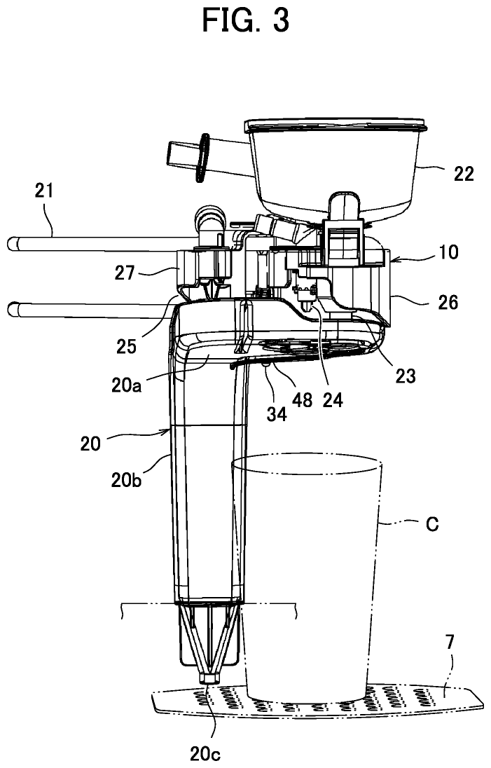

FIG. 3 is a front view illustrating a configuration of the nozzle unit 10 and a nozzle lower tray 20.

As shown in FIG. 3, the nozzle unit 10 is supported by the body part 3 detachably therefrom via a support member 21 formed by bending a round bar into a substantially U shape.

The nozzle unit 10 is provided with a buffer 22 that temporarily stores coffee extracted by the extraction unit, a coffee nozzle 23 fixed below the buffer 22 to supply coffee from a pour spout below the buffer 22, a hot water/water nozzle 24 that supplies other beverages such as hot water/water, a milk nozzle 25 (nozzle) that supplies raw milk supplied from the raw milk tank or milk obtained by whipping the raw milk, a fixed nozzle support unit 26 that supports the buffer 22, the coffee nozzle 23 and the hot water/water nozzle 24, and a movable nozzle support unit 27 (nozzle support unit) that supports the milk nozzle 25.

The nozzle lower tray 20 is provided below the nozzle unit 10. The nozzle lower tray 20 includes a tray 20a that receives post-drip from the milk nozzle 25. The tray 20a is placed at a position in the vertical direction between each nozzle 23, 24 or 25 and the cup C disposed at the cup station 7. A cylinder part 20b extending in the vertical direction integrally molded with the tray 20a is provided at a rear end part of the nozzle lower tray 20. The cylinder part 20b is provided with a discharge port 20c at its bottom end part and detachably fixed at a lower part of the body part 3. The top surface of the tray 20a is inclined downward toward the cylinder part 20b, a liquid dropping on the top surface of the tray 20a is directed to the cylinder part 20b, and is configured to flow downward through the cylinder part 20b and be discharged into a drainage tray 28 placed below the body part 3.

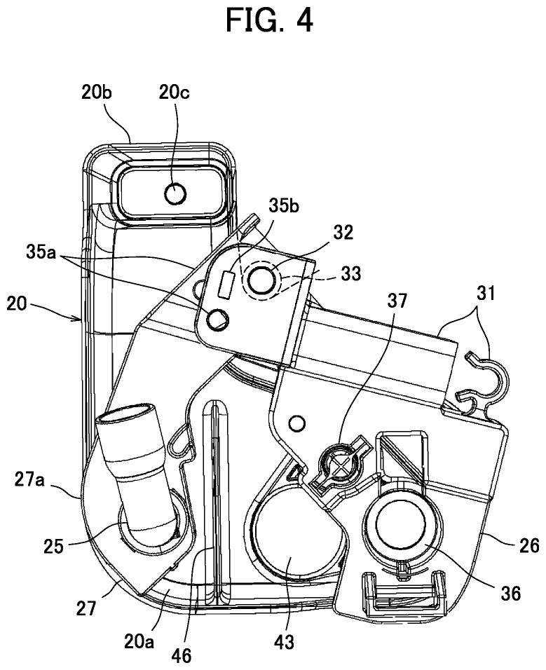

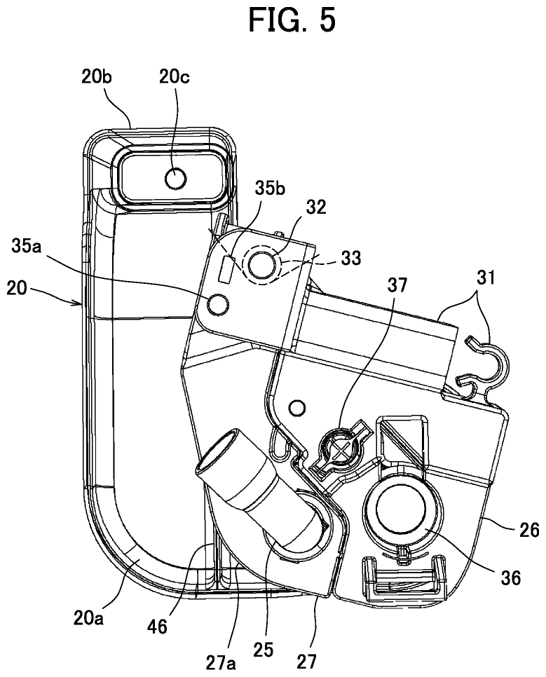

FIGS. 4 and 5 are top views illustrating configurations of the nozzle support units 26 and 27, and the nozzle lower tray 20. FIG. 4 illustrates a state when milk is not supplied and FIG. 5 illustrates a state when milk is supplied.

As shown in FIGS. 4 and 5, the fixed nozzle support unit 26 is provided with a support member fixing part 31 detachably fixed to a bent part of the support member 21.

The movable nozzle support unit 27 is horizontally swingably supported with respect to the fixed nozzle support unit 26 via a pin 32 extending in the vertical direction.

A torsion spring 33 (first biasing means) biasing the movable nozzle support unit 27 toward a direction away from the fixed nozzle support unit 26 is provided around the circumference of the pin 32. The fixed nozzle support unit 26 or the movable nozzle support unit 27 is provided with a stopper (not shown) for restricting the movable nozzle support unit 27, when it moves in a direction away from the fixed nozzle support unit 26 up to a predetermined position (standby position: corresponding to the second position of the present invention), from further moving in the separating direction.

Thus, the movable nozzle support unit 27 is configured to be swingable between the standby position away from the fixed nozzle support unit 26 shown in FIG. 4 and a position in contact with the fixed nozzle support unit 26 (supply position: corresponding to the first position of the present invention) shown in FIG. 5. With a bias by the torsion spring 33, the movable nozzle support unit 27 is normally located at the standby position shown in FIG. 4.

Furthermore, the fixed nozzle support unit 26 is provided with a protruding part 34 that protrudes downward in such a way that its distal end is tapered in a downward direction at a lower position coaxial with the pin 32.

The fixed nozzle support unit 26 and the movable nozzle support unit 27 are provided with through holes vertically penetrating regions overlapping in the vertical direction when the movable nozzle support unit 27 is positioned at a supply position. There are two such through holes: a circular through hole 35a and a rectangular through hole 35b into which the distal end part of the key 4 for locking the door 2 can be inserted, which are provided for the fixed nozzle support unit 26 and the movable nozzle support unit 27 respectively. As shown in FIG. 5, with the movable nozzle support unit 27 positioned at the supply position, an insertable pin or the distal end part of the key 4 is inserted into at least one of the two through holes 35a and 35b, and it is thereby possible to hold the movable nozzle support unit 27 positioned at the supply position. Note that the through holes 35a and 35b provided for the fixed nozzle support unit 26 and the movable nozzle support unit 27 respectively and a pin and a key 4 which are inserted into these through holes correspond to the holding means of the present invention.

The fixed nozzle support unit 26 is provided with a coffee nozzle support hole 36 perforated in the vertical direction to support the coffee nozzle 23 inserted from above and a hot water/water nozzle support hole 37 perforated in the vertical direction to support the hot water/water nozzle 24 inserted from above.

The movable nozzle support unit 27 is provided with a milk nozzle support hole perforated in the vertical direction to support the milk nozzle 25 inserted from above. Note that FIGS. 4 and 5 illustrate a state in which the milk nozzle 25 is inserted into the milk nozzle support hole of the movable nozzle support unit 27 and supported.

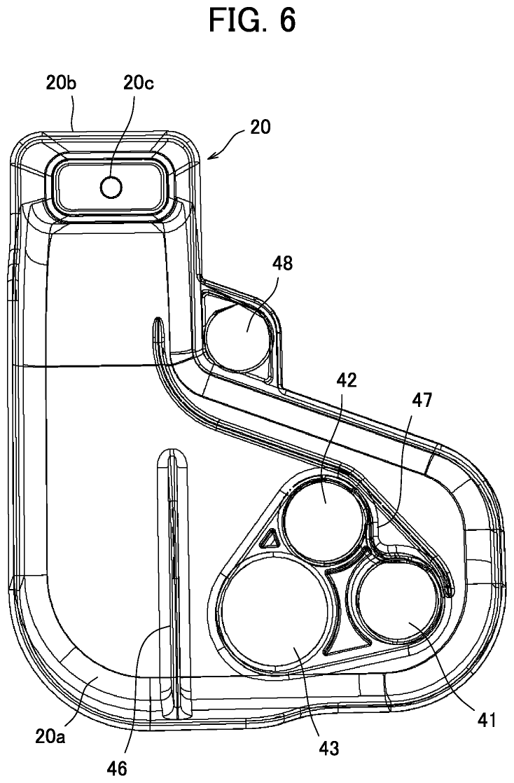

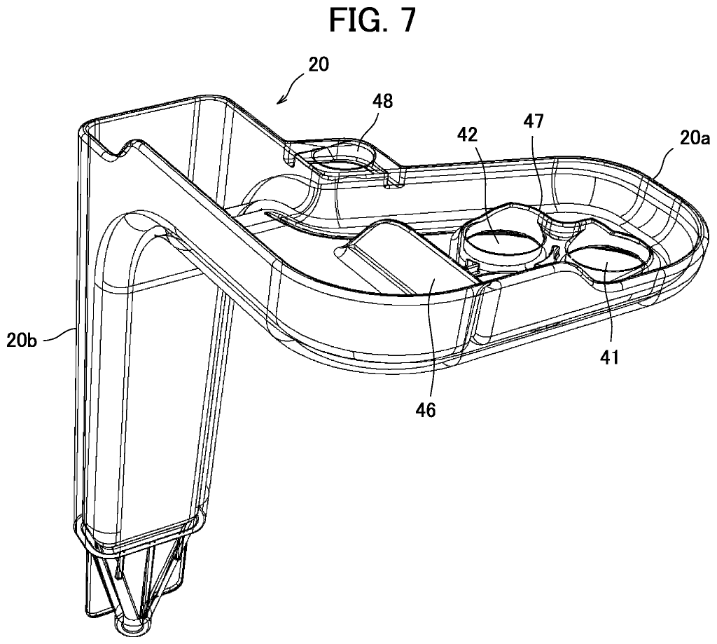

FIG. 6 is a top view of a nozzle lower tray 20. FIG. 7 is a perspective view of the nozzle lower tray 20.

As shown in FIGS. 6 and 7, the tray 20a of the nozzle lower tray 20 is provided with holes 41 and 42 which are slightly larger than the holes of the nozzles 23 and 24 in the regions positioned below the coffee nozzle 23 and the hot water/water nozzle 24 respectively. As described above, although the tray 20a of the nozzle lower tray 20 is placed below the nozzle unit 10, a beverage such as coffee poured vertically downward from the coffee nozzle 23 or the hot water/water nozzle 24 passes through the hole 41 or 42 of the nozzle lower tray 20 and is supplied into the cup C placed at the cup station 7.

The tray 20a of the nozzle lower tray 20 is also provided with a hole 43 in the region positioned below the milk nozzle 25 when the movable nozzle support unit 27 is positioned at the supply position. Milk poured vertically downward from the milk nozzle 25 passes through the hole 43 of the nozzle lower tray 20 and is supplied into the cup C placed at the cup station 7. Sizes and positions of the holes 41, 42 and 43 provided in the tray 20a of the nozzle lower tray 20 are set in such a way that beverages poured from the respective nozzles 23, 24 and 25 do not scatter from the edge of the cup C placed at a predetermined position of the cup station 7 or to the outside of the cup C.

The tray 20a of the nozzle lower tray 20 is provided so as to include the position below the milk nozzle 25 when the movable nozzle support unit 27 is positioned at a standby position and placed so as to surely receive milk dropping from the milk nozzle 25 at the standby position.

The tray 20a of the nozzle lower tray 20 is provided both around the holes 41, 42 and 43 provided below the milk nozzle 25, the coffee nozzle 23 and the hot water/water nozzle 24 when the movable nozzle support unit 27 is positioned at the supply position and at the position below the milk nozzle 25 when the movable nozzle support unit 27 is positioned at the standby position, and these regions are integrally formed, and so it is possible to share the cylinder part 20b that discharges the liquid received at the tray 20a and miniaturize the nozzle lower tray 20.

Furthermore, on the top surface of the tray 20a of the nozzle lower tray 20, there is a first partition part 46 that protrudes upward between the region below the milk nozzle 25 when the movable nozzle support unit 27 is positioned at the standby position and the regions where the holes 41, 42 and 43 are provided so as to partition these regions.

This first partition part 46 allows the milk that has dropped from the milk nozzle 25 when the movable nozzle support unit 27 is positioned at the standby position to be discharged into the cylinder part 20b without flowing into the holes 41, 42 and 43.

On the top surface of the tray 20a, there is also a second partition part 47 that protrudes upward at edges of the hole 41 below the coffee nozzle 23 and the hole 42 below the hot water/water nozzle 24. This is attributable to a structure in which the coffee nozzle 23 is provided with a discharge hole for discharging post-drip of coffee poured from the buffer 22 to a side on the rear side and post-drip of coffee dripping from the discharge hole drops to a region behind the hole 41 and the hole 42 in the tray 20a. This second partition part 47 is configured to cause a liquid such as coffee dropping behind the hole 41 below the coffee nozzle 23 and the hole 42 below the hot water/water nozzle 24 to be discharged into the cylinder part 20b without flowing into the holes 41 and 42.

The nozzle lower tray 20 is provided with a support hole 48 into which a distal end of the protruding part 34 provided below the pin 32 of the fixed nozzle support unit 26 is inserted. The fixed nozzle support unit 26 and the nozzle lower tray 20 are connected by inserting the protruding part 34 of the fixed nozzle support unit 26 into this support hole 48. Therefore, the fixed nozzle support unit 26 is not only supported by the body part 3 via the support member 21 but also supported by the body part 3 via the nozzle lower tray 20. Even if an operator mistakenly contacts and pushes the nozzle lower tray 20 or the nozzle unit 10, for example, during maintenance, it is possible to prevent fall of the nozzle lower tray 20, dropout of the nozzle unit 10, or the like.

When the protruding part 34 of the fixed nozzle support unit 26 is inserted into the support hole 48 of the nozzle lower tray 20, positioning in the horizontal direction of the nozzle lower tray 20 and the fixed nozzle support unit 26 is done. Positionings in the horizontal direction of the respective nozzles 23, 24 and 25, and the nozzle lower tray 20 are precisely done, making it possible to accurately supply a beverage such as milk from the respective nozzles 23, 24 and 25 to the cup C, accurately receive post-drip or scattering of the beverage from the respective nozzles 23, 24 and 25 by the tray 20a of the nozzle lower tray 20 and discharge the beverage into the drainage tray 28.

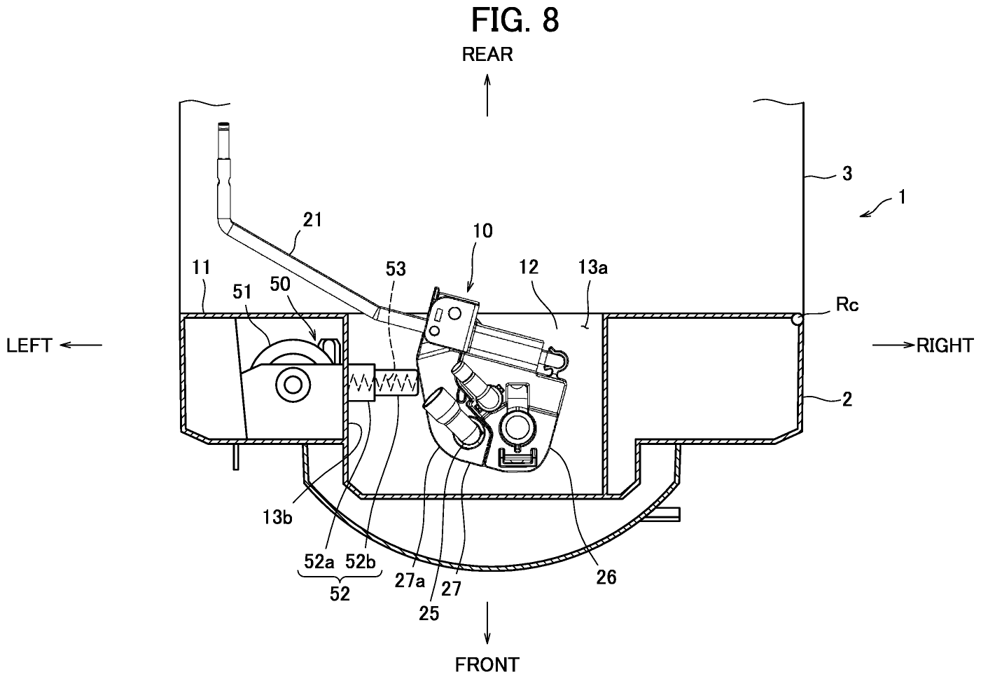

FIG. 8 is a traverse cross-sectional view illustrating states of the nozzle unit 10 and a nozzle moving unit 50 when milk is supplied. FIG. 8 is a cross-sectional view along an A-A part described in FIG. 1, illustrating a state in which the door 2 is closed and the movable nozzle support unit 27 is positioned at the supply position.

As shown in FIG. 8, the door 2 is provided with the nozzle moving unit 50 for moving the movable nozzle support unit 27.

The nozzle moving unit 50 is disposed in an inner space on the movable nozzle support unit 27 side (left side in FIG. 8) with respect to the space 12 storing the nozzle unit 10 of the door 2.

The nozzle moving unit 50 is provided with an electrically driven actuator 51 and a pusher 52 that pushes the movable nozzle support unit 27.

The pusher 52 is provided with a cylindrically formed proximal end part 52a and a distal end part 52b inserted into the proximal end part 52a and extendable/retractable with respect to the proximal end part 52a. The pusher 52 has a compression coil spring 53 (second biasing means) that biases the distal end part 52b in the extension direction with respect to the proximal end part 52a.

The pusher 52 is disposed at the same vertical position as that of the movable nozzle support unit 27 and disposed to be movable in the horizontal direction (left-right direction) with respect to the door 2.

A hole through which the proximal end part 52a of the pusher 52 passes is provided in the partition wall 13 that partitions the space 12 in which the nozzle unit 10 is stored on the movable nozzle support unit 27 side, that is, in a partition wall 13b on the left side in FIG. 8. This hole is formed to an extent that it does not touch the proximal end part 52a of the pusher 52 and so as to minimize a gap with the proximal end part 52a.

The actuator 51 has a function of moving the proximal end part 52a of the pusher 52 in the left-right direction with respect to the door 2, and may be constructed of, for example, an electric motor and a mechanism that converts rotation by the electric motor to straight-going motion or may be constructed of a straight-going motion type solenoid. However, an electric motor is more preferable than the solenoid for the actuator 51. Since the electric motor rather than the solenoid can cause the pusher 52 to extend/contract more smoothly, thus allowing the movable nozzle support unit 27 to move smoothly. After milk is supplied, it is thereby possible to prevent milk remaining in the milk nozzle 25 from scattering when the movable nozzle support unit 27 moves.

As shown in FIG. 8, while the door 2 is closed, when the actuator 51 is operated to move the pusher 52 toward the movable nozzle support unit 27, the distal end part 52b of the pusher 52 pushes a side face 27a of the movable nozzle support unit 27. Note that a biasing force by the compression coil spring 53 of the pusher 52 is set to be greater than a biasing force on the movable nozzle support unit 27 by the torsion spring 33 provided in the nozzle unit 10. Therefore, when the actuator 51 is operated to cause the distal end part 52b of the pusher 52 to push the movable nozzle support unit 27, the movable nozzle support unit 27 moves toward the fixed nozzle support unit 26. At this time, the position of the pusher 52 is set so that the movable nozzle support unit 27 moves to the supply position.

On the other hand, when the actuator 51 performs contraction motion to cause the pusher 52 to move in a direction away from the movable nozzle support unit 27, the movable nozzle support unit 27 moves to the standby position by a biasing force of the torsion spring 33, and the amount of movement of the pusher 52 is set so that the distal end part 52b of the pusher 52 moves away from the movable nozzle support unit 27.

As shown in FIG. 8, the side face 27a of the movable nozzle support unit 27 to which the distal end part 52b of the pusher 52 comes into contact is chamfered roundly so as to have a substantially arcuate shape centered on a swing fulcrum Rc for opening/closing the door 2 in the movable nozzle support unit 27 located at the supply position.

The coffee machine 1 in the above configuration operates and controls the actuator 51 of the nozzle moving unit 50 to cause the pusher 52 to perform extension motion only when milk or the like is supplied from the milk nozzle 25 and moves the movable nozzle support unit 27 to the supply position. Except in the case where milk is supplied, for example, after milk is supplied, the actuator 51 causes the pusher 52 to perform contraction motion to thereby move the movable nozzle support unit 27 to the standby position.

After milk is supplied, since the movable nozzle support unit 27 moves to the standby position, even when post-drip of milk drips from the milk nozzle 25, the milk drops into the tray 20a of the nozzle lower tray 20, passes through the cylinder part 20b and is discharged into the drainage tray 28. Thus, it is then possible to prevent post-drip of milk from mixing into the cup C placed at the cup station 7. Therefore, when a beverage not using milk such as straight coffee is provided to the next cup, it is possible to prevent a mixture of milk and safely provide a beverage not using milk to, for example, a user having allergy to milk with the next cup.

Note that the coffee machine 1 according to the present embodiment is provided with a cleaning unit (not shown) that discharges compressed air and hot water from the milk nozzle 25. Every time after supplying milk from the milk nozzle 25, the coffee machine 1 discharges air from the milk nozzle 25 for a certain time first, then discharges hot water and thereby enables rising operation to clean the milk nozzle 25 and a milk supply path.

In the present embodiment, through control whereby the movable nozzle support unit 27 is moved to the standby position after milk is supplied to then perform rinsing operation, it is possible to receive milk or hot water remaining in the milk supply path after being poured from the milk nozzle 25 by the tray 20a of the nozzle lower tray 20 and prevent the milk from scattering to the partition wall 13 or the like. The coffee machine 1 is provided with a locking mechanism for locking the slide door 6 during rinsing operation. However, due to a failure of this locking mechanism or damage to the slide door 6, even if the operator's finger is mistakenly placed in the cup station 7 during the rinsing operation, hot water discharged from the milk nozzle 25 is received by the tray 20a of the nozzle lower tray 20, and so it is possible to avoid burning of a hand or finger.

Furthermore, since the tray 20a is provided below the coffee nozzle 23 or the hot water/water nozzle 24, even when a liquid such as coffee scatters from the coffee nozzle 23 or the hot water/water nozzle 24, the tray 20a of the nozzle lower tray 20 receives it, thus making it possible to prevent scattering of the coffee over the partition wall 13 or the like.

When performing maintenance such as cleaning of the nozzle unit 10 in the coffee machine 1 of the present embodiment, by opening the door 2 and removing the nozzle unit 10 from the support member 21, it is possible to clean the buffer 22 and each nozzle 23, 24 or 25. The nozzle lower tray 20 can also be removed from the body part 3 and cleaned.

In the coffee machine 1 of the present embodiment, the nozzle moving unit 50 that operates the movable nozzle support unit 27 is provided separately from the nozzle unit 10 and the nozzle moving unit 50 need not be removed when cleaning the nozzle unit 10, making it possible to easily perform maintenance such as cleaning of the nozzle unit 10. Furthermore, since the nozzle moving unit 50 is provided in the door 2, the nozzle unit 10 and the body part 3 can be separated from each other by opening the door 2 during maintenance. Even when internal cleaning is performed whereby the inside of the nozzle unit 10 set in the body part 3 or the inside of the body part 3 in the periphery is cleaned with hot water, it is possible to prevent scattering over the actuator 51 of the nozzle moving unit 50 and protect the actuator 51.

Since the movable nozzle support unit 27 is biased to the standby position by the torsion spring 33, if the pusher 52 is in a contracted state, the milk nozzle 25 can be reliably positioned above the tray 20a of the nozzle lower tray 20. When the door 2 is mistakenly opened while milk is being poured from the milk nozzle 25, the pusher 52 is separated and the movable nozzle support unit 27 is moved to the standby position by the torsion spring 33, and so even when milk continues to be poured from the milk nozzle 25, the milk is discharged into the nozzle lower tray 20, making it possible to prevent the milk from spoiling areas of the body part 3 below the nozzle unit 10.

The pusher 52 that moves the movable nozzle support unit 27 can be moved by the actuator 51 of the nozzle moving unit 50 and the distal end part 52b has a two-stage extendable structure. The distal end part 52b is biased by the compression coil spring 53 in the extending direction and even when the movable nozzle support unit 27 is operated at the supply position, the compression coil spring 53 biases the distal end part 52b in the extending direction and biases the movable nozzle support unit 27 to the fixed nozzle support unit 26 side, and so when milk is supplied, it is possible to absorb errors in the mounting positions or the like of the movable nozzle support unit 27, the fixed nozzle support unit 26, the actuator 51 and the pusher 52 and ensure that the movable nozzle support unit 27 comes into contact with the fixed nozzle support unit 26. In this way, when milk is supplied, it is possible to ensure that milk poured from the milk nozzle 25 passes through the hole 43 of the nozzle lower tray 20 and is supplied into the cup C placed at the cup station 7.

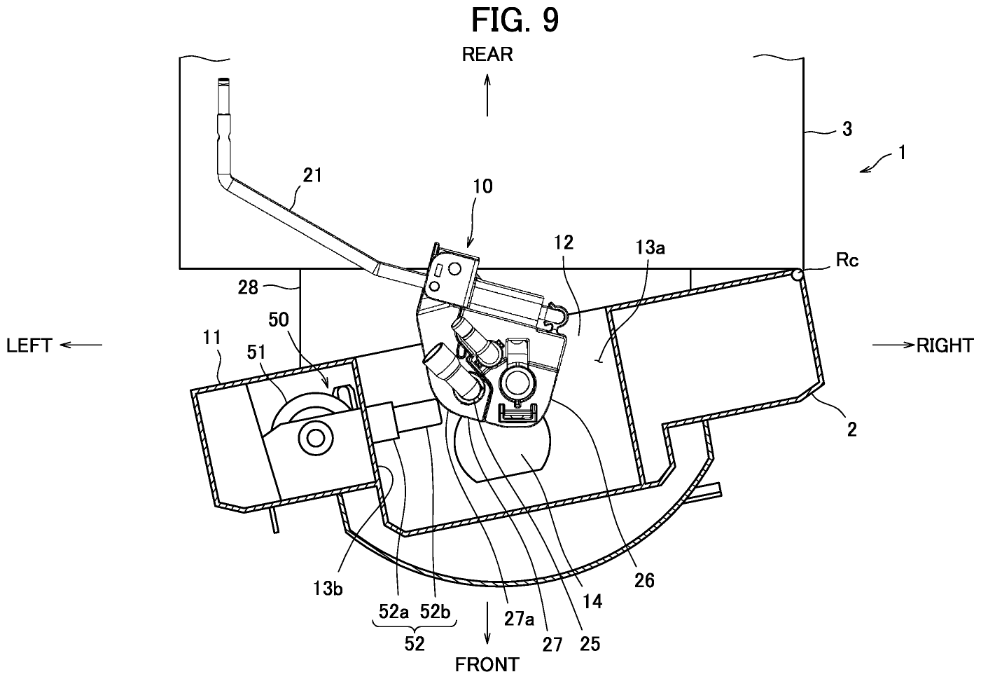

FIG. 9 is a traverse cross-sectional view illustrating states of the nozzle unit 10 and the nozzle moving unit 50 while the door 2 is being opened. As in the case of FIG. 8, FIG. 9 is a cross-sectional view along an A-A part described in FIG. 1.

As shown in FIG. 9, since the side face 27a of the movable nozzle support unit 27 is chamfered roundly so as to have a substantially arcuate shape centered on a swing fulcrum Rc of the door 2, even when the actuator 51 is stopped when the pusher 52 extends and protrudes due to a power failure or fault or the like, the door 2 can be opened/closed without being caught in the movable nozzle support unit 27. Since the distal end part 52b of the pusher 52 has an extendible structure, when the actuator 51 is stopped while the pusher 52 has extended and protruded, the door 2 can be easily opened/closed when the door 2 is opened/closed. The interior of the body part 3 can be thereby inspected.

Since the movable nozzle support unit 27 and the fixed nozzle support unit 26 are provided with the through holes 35a and 35b communicating therewith with the movable nozzle support unit 27 set at the supply position, by inserting a pin or a distal end of the key 4 into the through hole 35a or 35b with the movable nozzle support unit 27 pushed at the supply position, it is possible to hold the movable nozzle support unit 27 at the supply position. In this way, when the door 2 is opened, when checking to see whether or not, for example, a predetermined amount of milk is poured from the milk nozzle 25, it is possible to easily confirm the amount of milk supplied by causing the milk to be poured into the cup placed below the nozzle unit 10. When performing maintenance operation of cleaning a milk supply system such as the milk nozzle 25 while discharging hot water, a large drainage recipient may be placed below the nozzle unit 10 to make it possible to discharge a large amount of hot water from the milk nozzle 25 and sufficiently clean the milk supply system.

Note that after the milk supply, the actuator 51 may be controlled so as to repeat extension/contraction motion several times after restricting the amount of extension of the pusher 52 so that the milk nozzle 25 moves between the standby position and the first partition part 46, and the movable nozzle support unit 27 may be caused to swing in the vicinity of the standby position. By causing the movable nozzle support unit 27 to swing several times after the milk supply, it is possible to shake milk remaining in the milk nozzle 25 off and discharge the milk into the tray 20a of the nozzle lower tray 20. It is thereby possible to further prevent post-drip of milk after the milk supply.

Note that the beverage supply apparatus of the present invention is not limited to the above embodiment.

For example, the movable nozzle support unit 27 may be structured to be biased by means of a spring or the like toward the supply position and may also be structured to include a plunger which is driven by the actuator provided at the door 2, connected with the movable nozzle support unit 27 to move and pull the movable nozzle support unit 27 toward the standby position.

The movable nozzle support unit 27 may be connected to the actuator by means of a rod so that the actuator causes the movable nozzle support unit 27 to swing. Such a configuration eliminates the necessity for the torsion spring 33 that biases the movable nozzle support unit 27. Note that in such cases, when the door 2 is opened, connections by means of the plunger and the rod are disconnected, whereas when the door 2 is closed, the movable nozzle support unit 27 is connected to the actuator by the plunger and the rod.

A structure may also be adopted in which a plunger is provided which is driven by the actuator and operated so as to be drawn in a direction away from the movable nozzle support unit 27 so that the movable nozzle support unit 27 is moved to the supply position by the plunger. For example, an extension/retraction reversing mechanism for reversing movement in extending direction and movement in contraction direction may be provided between the actuator and the movable nozzle support unit 27, so that the movement by the actuator in the contraction (drawing) direction is reversed by the extension/retraction reversing mechanism so as to push the movable nozzle support unit 27. Alternatively, the milk nozzle 25 side of the movable nozzle support unit 27 may be moved to the supply position by extending the movable nozzle support unit 27 to the opposite side of the position of the milk nozzle 25 with respect to the pin 32 and causing the actuator to pull in the extended region via the plunger. Note that the torsion spring 33 for biasing the movable nozzle support unit 27 to the standby position is necessary in this case.

In this way, the mechanism for moving the movable nozzle support unit 27 and the structure of the movable nozzle support unit 27 may be changed as appropriate.

The cup station at which a cup is placed is not limited to the cup station 7 provided in the door 2 as described in the above embodiment, but may also have a configuration in which a cup is held by a cup holder or a configuration in which a beverage is supplied into a cup at a predetermined position in the body part 3 and then transferred to a takeout port and provided.

The coffee machine 1 of the above embodiment is configured to supply milk obtained by whipping raw milk from a milk nozzle, but the present invention is also applicable to a coffee machine that supplies milk obtained by dissolving powdered milk in hot water to the cup C. The present invention is also widely applicable to an apparatus that provides beverage other than milk or coffee such as cocoa or green tea.

### EXPLANATION OF REFERENCE SIGNS

1 coffee machine (beverage supply apparatus)

2 door

3 body part

4 key (holding means)

7 cup station

25 milk nozzle (nozzle)

27 movable nozzle support unit (nozzle support unit)

33 torsion spring (first biasing means)

35a through hole (holding means)

35b through hole (holding means)

51 actuator

52 pusher

52a proximal end part

52b distal end part

53 compression coil spring (second biasing means)

1. A beverage supply apparatus provided with a body part, a door openably/closably supported by the body part and a cup station at which a cup is placed, the beverage supply apparatus supplying a beverage from a nozzle, a distal end of which is disposed above the cup, to the cup placed at the cup station, the beverage supply apparatus comprising:
a nozzle support unit that supports the nozzle and is disposed in the body part so as to be movable between a first position at which the distal end of the nozzle is above the cup while the door is closed and a second position which is a position where the distal end of the nozzle is retracted from above the cup; and
an actuator that is disposed at the door and moves the nozzle support unit.

2. The beverage supply apparatus according to claim 1, further comprising first biasing means for biasing the nozzle support unit toward the second position.

3. The beverage supply apparatus according to claim 2, further comprising a pusher that is driven by the actuator to protrude, push the nozzle support unit and move the nozzle support unit to the first position, wherein
the pusher comprises:
a proximal end part that is moved by the actuator;
a distal end part that is extendible with respect to the proximal end part and pushes the nozzle support unit; and
second biasing means for biasing the distal end part in an extending direction with respect to the proximal end part.

4. The beverage supply apparatus according to claim 2, further comprising holding means for holding the nozzle support unit at the first position.

5. The beverage supply apparatus according to claim 3, further comprising holding means for holding the nozzle support unit at the first position.
